(19) United States
(12) Patent Application Publication
(10) Pub. No.: US 2024/0221967 A1
(43) Pub. Date: Jul. 4, 2024

(54) SYSTEM AND METHOD TO STABILIZE RADIOACTIVE ISOTOPES

(71) Applicant: Charles Allen Williams, Summerville, SC (US)

(72) Inventor: Charles Allen Williams, Summerville, SC (US)

(21) Appl. No.: 18/401,963

(22) Filed: Jan. 2, 2024

Related U.S. Application Data
(60) Provisional application No. 63/478,370, filed on Jan. 4, 2023.

(51) Int. Cl. G21F 9/30

(52) U.S. Cl. CPC G21F 9/304

(57) ABSTRACT

A method for stabilizing radioactive isotopes includes preparing a liquid solution and mixing the liquid solution with Cement Kiln Dust (CKD) powder to form a solid material. The method may further include crushing the solid material into particles and passing radioactive water through the solid material to remove radioactive isotopes from the radioactive water and stabilize the radioactive isotopes.

### CROSS-REFERENCE TO RELATED APPLICATION

This application claims the benefit of priority of U.S. provisional application No. 63/478,370, filed Jan. 4, 2023, the contents of which are herein incorporated by reference.

### BACKGROUND OF THE INVENTION

### Field of the Invention

The present invention relates to a system and method to stabilize radioactive isotopes and attenuate radioactivity.

### Description of the Related Art

Radioactive waste management involves a series of stages, including planning and preparation, treatment, packaging, storage, and disposal. Radioactive waste is hazardous to the environment, as it contains radioactive material. Radioactive waste may cause hazards in storing, handling, and disposal of such waste. The storage, handling, and disposal of the radioactive waste may be expensive.

Various ways to stabilize radioactive isotopes are known. U.S. Pat. No. 11,482,347 to Takatsuka, for example, discloses a process in which tritium radiation is attenuated or eliminated from radioactive contaminated water by a method which includes: (1) adding a predetermined amount of a mineral powder (e.g., silicon dioxide ore) and a nano-level carbon liquid to tritium-contaminated water in an addition-treatment tank; (2) pumping the addition-treated water from the addition-treatment tank to a mineral solid-filled tank; (3) causing addition-treated water to impact a mineral solid and passing the addition-treated water through the mineral solid-filled tank; (4) returning the mineral tank-passed water to the treatment tank; and (5) repeating steps (1)-(4) for a predetermined amount of time.

U.S. Pat. No. 10,593,437 to Mason discloses an apparatus for treating radioactive waste which includes organic, sulfur-containing and/or halogen-containing compounds. The apparatus includes a reaction vessel. The vessel includes a filter for carrying out thermal treatment of the waste and a thermal oxidizer. When in operation, the apparatus utilizes co-reactants to reduce gas phase sulfur and halogen from treatment of wastes.

U.S. Pat. No. 9,336,913 to Sumiya et al. discloses a method for treating radioactive organic waste. The waste includes a cation exchange resin used to adsorb radionuclide ions. The method includes bringing the radioactive organic waste into contact with an organic acid salt aqueous solution containing an organic acid salt. Such contact desorbs the radionuclide ions from the cation exchange resin, which results in the organic acid salt contained in the organic acid salt aqueous solution providing a cation that is more readily adsorbable by the cation exchange resin than hydrogen ion is. This method, in operation, reduces the concentration of a radioactive substance in the radioactive organic waste and reduces the amount of a high-dose radioactive material present in the waste.

U.S. Pat. No. 7,091,393 to Chekhmir et al. discloses processes for immobilizing waste that contains radionuclides, hazardous elements, hazardous compounds, and/or other compounds present. Each process creates a barrier against leaching and diffusion of the waste. The first barrier is created by integrating the waste with an immobilizing mineral. The second barrier is a layer of non-radioactive or non-hazardous material that covers the first barrier. The second barrier may be created using an overgrowth procedure or by sintering. The third barrier is created by a rock or glass matrix that surrounds the first and/or second barriers. The fourth barrier is created by ensuring that the rock or glass has the same or similar composition as the indigenous rock at the disposal site. The resultant rock or glass matrix is in equilibrium with the groundwater or local hydrothermal solutions that are saturated with components of the indigenous rock of the disposal area.

U.S. Pat. No. 5,960,368 to Pierce et al. discloses a process for reducing volume of low level radioactive and mixed waste to enable the waste to be stored more efficiently in a preselected repository and transforming the waste into a preselected shape and size for permanent disposal. The process includes preparing a radioactive and/or a hazardous waste-bearing material containing organic carbon-containing compounds and radioactive or hazardous waste components for storage by contacting the waste-bearing material with nitric acid and phosphoric acid at a contacting temperature within a range of about 140° C. to about 210° C. for a period of time effective for oxidizing at least a portion of the organic carbon-containing compounds to gaseous products, thereby producing a residual concentrated subsequent waste-bearing product containing essentially all the radioactive or inorganic hazardous waste component. The process includes immobilizing the residual concentrated waste within a solid matrix formed from phosphate-based ceramic or glass.

U.S. Pat. No. 5,678,234 to Colombo et al. discloses a process for encapsulating and stabilizing radioactive and/or hazardous waste in a modified sulfur cement composition. The waste could be incinerator fly ash or bottom ash including radioactive contaminants, toxic metal salts, and other wastes commonly found in refuse. The process may use glass fibers mixed into the composition to improve the tensile strength and a low concentration of anhydrous sodium sulfide to reduce toxic metal solubility. The process includes combining anhydrous wastes, molten modified sulfur cement, glass fibers, and anhydrous sodium sulfide or calcium hydroxide or sodium hydroxide in a heated preselected mixer. The modified sulfur cement is preheated to about 135°±5° C. Then substantially dry anhydrous ingredients are added and mixed to homogeneity. Next, the homogeneous molten mixture is poured or extruded into a mold. The mold is allowed to cool, while the mixture hardens, for immobilizing and encapsulating the contaminants present in the ash.

U.S. Pat. No. 5,288,435 to Sachse et al. discloses an apparatus and a process for incinerating and vitrifying radioactive waste materials. Waste materials are fed into a high temperature vessel containing molten glass, in which the waste is incinerated, becoming vitrified into a resulting glass matrix. U.S. Pat. No. 5,202,062 to Baba et al. discloses a process which includes adding carbonates or chlorides of alkaline earth metals to radioactive waste containing sodium sulfate. The process includes subjecting sulfate groups in the radioactive waste, to convert sulfate groups into sulfides of alkaline earth metals (especially sulfides of alkaline earth metals that are chemically stable substances), and solidifying the radioactive wastes, for stabilizing the wastes for an extended period.

U.S. Pat. No. 4,648,990 to Uetake et al. discloses a process for immobilizing certain radioactive wastes containing water-soluble solid components with an effective amount of an alkaline earth metal silicate compound. In this process, the alkaline earth metal silicate compound intakes a portion of the water into a solidifying agent as bound water or as a hydrate. High temperature and high humidity conditions have been found to be necessary on curing, for achieving reduction of water content and take-up of bound water.

Problems resulting from the production and/or generation of radioactive waste, of course, include various hazards and associated expenses involving disposal of the waste.

Thus, there exists a need for a system and method that eliminates the hazards caused by the radioactive waste at a low cost.

### SUMMARY OF THE INVENTION

The following presents a simplified summary of the present disclosure in a simplified form as a prelude to the more detailed description that is presented herein.

In accordance with embodiments of the invention, there is provided a method for stabilizing radioactive isotopes. The method may include preparing a liquid solution and mixing the liquid solution with Cement Kiln Dust (CKD) powder to form a solid material. The method may further include crushing the solid material into particles and passing radioactive water through the solid material to remove radioactive isotopes from the water and stabilize the radioactive isotopes.

In some aspects, the step of preparing the liquid solution may include adding iron, sulfur, copper, calcium, and magnesium into hot water to form a first mixture. In further aspects, the step of mixing the liquid solution with the CKD powder to form the solid material may include mixing and combining about 5 weight percent (weight %) of the first mixture with about 20-40 weight % of the CKD powder to produce a second mixture. As used herein, the term “hot water” refers to liquid water having a temperature of about 212° F. As used herein, the term “weight percent” refers to a percentage of a total solids content, which in water is limited by a saturation point of about 29%.

The method may further include adding about 10-40 weight % liquid sulfur and xanthan gum glyoxal to the second mixture to produce a third mixture. The method may further include adding and mixing about 10-30 weight % sodium hydroxide with the third mixture to produce a fourth mixture. The method may further include adding about 20-100 weight % hot water with the fourth mixture to produce a fifth mixture.

The method may further include separating a first cut solid and a second cut aqueous extract from the fifth mixture, preparing a second cut solid and a second cut aqueous extract from the first cut solid and the second cut aqueous extract, and preparing a third cut solid and a third cut aqueous extract from the second cut solid and a second cut aqueous extract. The method may further include combining the third cut aqueous extract with about 25 weight % cement to produce the solid material.

The present disclosure discloses a method to stabilize radioactive atoms, to eliminate hazards associated with the storage, handling, and disposal of radioactive waste. The present disclosure may be used to stabilize radioactive isotopes and attenuate radioactivity, to reduce costs associated with transportation and disposal of radioactive waste. Thus, the present disclosure provides an economical solution to stabilize the radioactive isotope and eliminates the hazards associated with storage, handling, and disposal of radioactive waste.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a first flow chart of a procedure for preparing a first-cut aqueous extract in accordance with the present disclosure.

FIG. 2 is a second flow chart of a procedure for preparing a second-cut aqueous extract in accordance with the present disclosure.

FIG. 3 is a third flow chart of a procedure for preparing a third-cut aqueous extract in accordance with the present disclosure.

FIG. 4 is a fourth flow chart of a process for making solids in accordance with the present disclosure.

FIG. 5 is a schematic diagram of a treatment system in accordance with the present disclosure.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

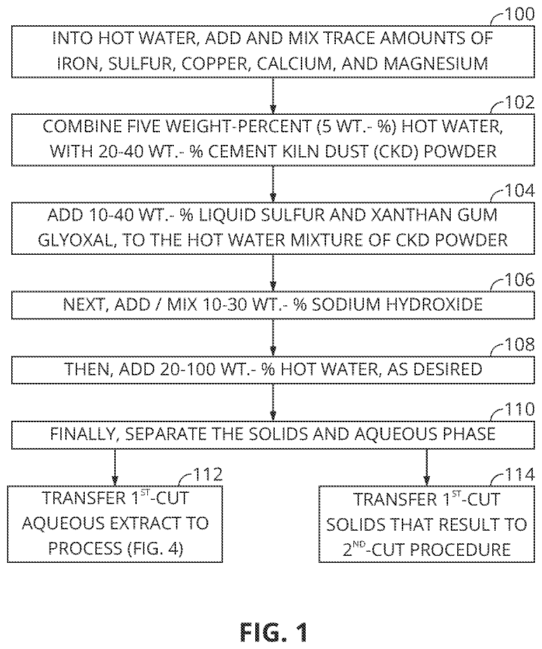

FIG. 1 is a first flow chart depicting a procedure/method for preparing a first-cut aqueous extract in accordance with the present disclosure. At step 100, the method may include adding and mixing trace amounts (i.e., parts per million as measured in ground water) of iron, sulfur, copper, calcium, and magnesium into hot water, which may form a first mixture. At step 102, the method may include combining about 5 weight % hot water (e.g., the first mixture), with about 20-40 weight % Cement Kiln Dust (CKD) powder for producing a second mixture.

Cement is a chemical substance that sets, hardens, and adheres to other materials for binding them together. Cement, seldom used on its own, is typically used to bind sand and gravel (aggregate) together. Cement, when mixed with fine particles, produces mortar for masonry, or when mixed with sand and/or gravel, produces concrete, the most widely used material in existence, which is behind only water as our most-consumed resource. Cements, usually inorganic and often lime or calcium silicate based, are characterized as either “hydraulic” or the less common “non-hydraulic,” depending upon the ability of the cement chosen to set in the presence of water. Hydraulic cements (e.g., Portland cement) set and become adhesive through a chemical reaction between the dry ingredients and water. The chemical reaction results in mineral hydrates that are not very water-soluble and thus quite durable in water and safe from chemical attack. This allows setting in wet conditions or under water, further protecting the hardened material from chemical attack. CKD is a residue produced during the manufacture of cement.

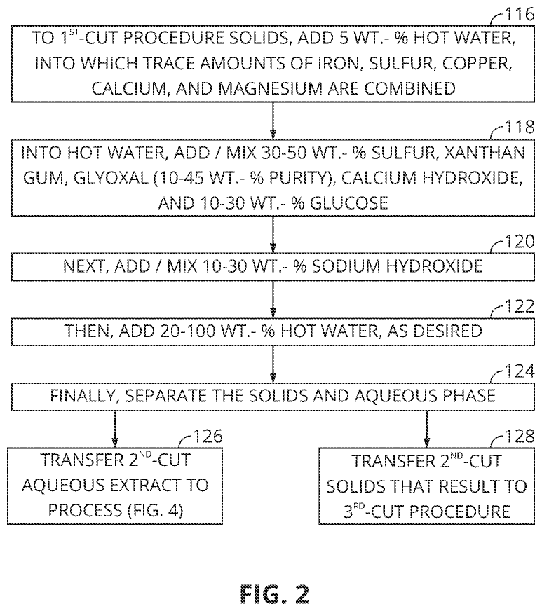

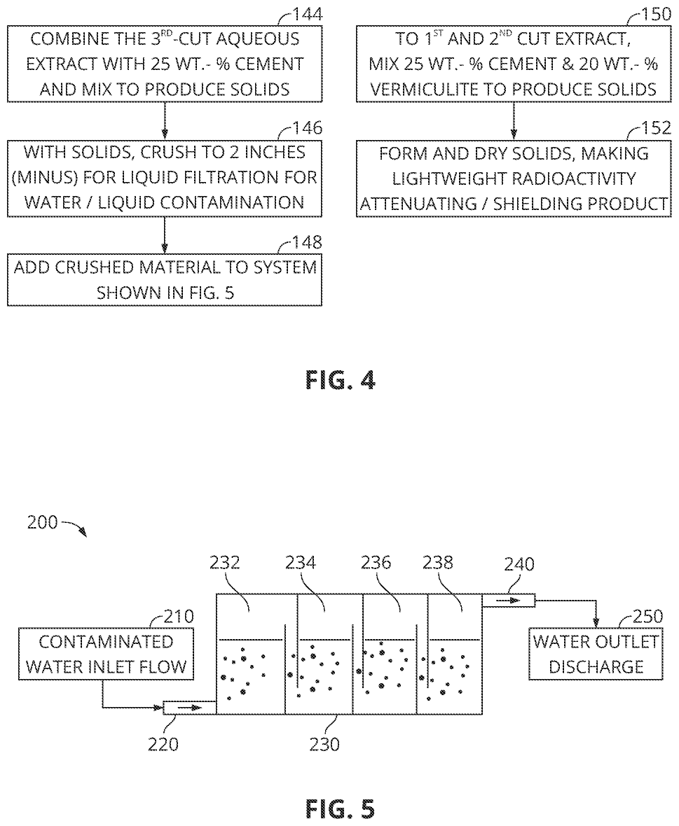

At step 104, the method may include adding about 10-40 weight % liquid sulfur and xanthan gum glyoxal, to the hot water mixture of CKD powder (or the second mixture) for producing a third mixture. At step 106, the method may include adding and mixing about 10-30 weight % sodium hydroxide to produce a fourth mixture. At step 108, the method may include adding about 20-100 weight % hot water, as desired, with the fourth mixture to produce a fifth mixture. At step 110, the method may include separating the solid and aqueous phases from the fifth mixture. At step 112, the method may include transferring a first cut aqueous extract to further processing (as described below in conjunction with FIG. 4). At step 114, the method may include transferring first cut solids that result to a second cut procedure. Stated another way, the method may include transferring the first cut solids to another procedure described in FIG. 2 for producing a second cut aqueous extract.

FIG. 2 depicts a second flow chart of a procedure for preparing a second-cut aqueous extract in accordance with the present disclosure. At step 116, the method may include adding, to the first cut procedure solids, about 5 weight % hot water into which iron, sulfur, copper, calcium, and magnesium are combined to produce a sixth mixture.

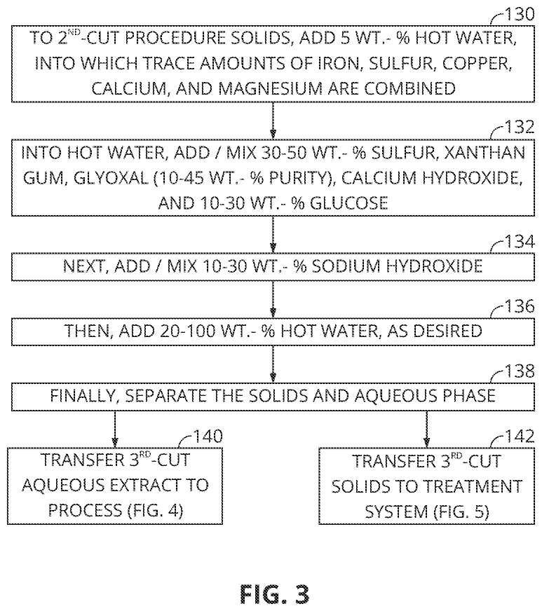

At step 118, the method may include adding and mixing, into the hot water (e.g., the sixth mixture), about 30-50 weight % sulfur, xanthan gum, glyoxal (about 10-45 weight % purity), calcium hydroxide, and about 10-30 weight % glucose to produce a seventh mixture. At step 120, the method may include adding and mixing about 10-30 weight % sodium hydroxide to the seventh mixture to produce an eighth mixture. At step 122, the method may include adding about 20-100 weight % hot water, as desired, to the eighth mixture to produce a ninth mixture. At step 124, the method may include separating the solids and aqueous phase from the ninth mixture. At step 126, the method may include transferring a second cut aqueous extract to further processing (as described below in conjunction with FIG. 4). At step 128, the method may include transferring second cut solids that result to a third cut procedure. Stated another way, the method may include transferring the second cut solids to another procedure described in FIG. 3 for producing a third cut aqueous extract.

FIG. 3 depicts a third flow chart of a procedure for preparing a third-cut aqueous extract in accordance with the present disclosure. At step 130, the method may include adding, to the second cut procedure solids (from the procedure described above in conjunction with FIG. 2), about 5 weight % hot water into which iron, sulfur, copper, calcium, and magnesium are combined to produce a tenth mixture.

At step 132, the method may include adding and mixing, into the hot water (e.g., the tenth mixture), about 30-50 weight % sulfur, xanthan gum, glyoxal (about 10-45 weight % purity), calcium hydroxide, and about 10-30 weight % glucose to produce an eleventh mixture. At step 134, the method may include adding and mixing about 10-30 weight % sodium hydroxide to the eleventh mixture to produce a twelfth mixture. At step 136, the method may include adding about 20-100 weight % hot water, as desired, to the twelfth mixture for producing a thirteenth mixture. At step 138, the method may include separating the solids and aqueous phase from the thirteenth mixture. At step 140, the method may include transferring a third cut aqueous extract to process (as described below in conjunction with FIG. 4). At step 142, the method may include transferring third cut solids to treatment system (as described below in conjunction with FIG. 5).

FIG. 4 depicts a fourth flow chart of a process for making solids in accordance with the present disclosure. In this process, the first-cut, the second-cut, and the third-cut aqueous extracts may be used at predetermined amounts to remove/stabilize radioactive atoms from water, materials, and surfaces. Each of the first-cut, the second-cut, and the third-cut aqueous extracts may be contaminated with predetermined radioactive materials. The contaminated aqueous extracts are combined with cement, as illustrated in FIG. 4, for stabilizing radioactive isotopes and attenuating radioactivity, to reduce the cost of their transportation and disposal.

At step 144, the method may include combining the third cut aqueous extract with about 25 weight % cement and mixing to produce solids. At step 146, the method may include crushing the solids to 2 inches (minus) particle size (meaning that the particles thus produced can pass through known commercial screens having 2-inch diameter openings) for liquid filtration for water/liquid contamination. At step 148, the method may include adding the crushed material to the system shown in FIG. 5.

At step 150, the method may include mixing, to the first cut and the second cut extract, about 25 weight % cement and about 20 weight % vermiculite to produce solids. At step 152, the method may include forming and drying solids, making a lightweight radioactivity attenuating/shielding product. As used herein, “lightweight” refers to a density less than the density of lead (708 lb/ft³), steel (489 lb/ft³), and concrete (150 lb/ft³). For example, the radioactivity attenuating/shielding product disclosed herein may have a density of about 60 lb/ft³.

FIG. 5 depicts a block diagram of a treatment system 200 in accordance with the present disclosure. The treatment system 200 may be configured to stabilize water and/or other liquids contaminated with radioactive material by removing radioactive material and/or reducing radioactivity levels from water and/or other liquids, in accordance with the present disclosure. The system 200 includes a holding tank 210 from which the contaminated water and/or other contaminated liquids or fluids are conveyed via a conduit 220 into a treatment zone 230 (or a treatment box). The treatment zone 230, which includes an outlet conduit 240, may be divided into a plurality of compartments 232, 234, 236, and 238 that are interconnected for permitting fluid flow from the conduit 220, though the plurality of compartments 232, 234, 236, and 238, seriatim, and then to the outlet conduit 240. The outlet conduit 240 may transfer the water and/or the other liquids or fluids treated by the treatment zone 230 (to remove radioactive material and/or reduce their radioactivity levels) to an outlet discharge tank 250, used as a holding tank until water and/or other liquids treated by the treatment zone 230 are desired for use. Radioactive liquid, e.g., water, is passed through the treatment zone 230 at a predetermined rate with the crushed solid product. The radioactive contaminants are attracted to the solid crushed material where they are bound. Liquid passing out of the treatment zone 230 may be free from contaminant or have a greatly reduced level of contamination.

The solid material may be used by pumping radioactive water through the treatment system 200 containing the solid product/material that causes the radioactive isotope to bind onto the solid product removing the radioactivity from the water and stabilizing the isotope on the solid product where it stays permanently bound to the solid product. Although the product is designed for radioactive isotopes, the method of present disclosure may be used to stabilize heavy metals as well. Details of a few example tests are provided below.

### Example 1: Procedure for Testing 99Tc Removal by PROTECTORATE (Rad Products Family Name) and Results

Procedure. 99TC (Technetium) was added to (oxic) aqueous solutions of BX (2^{nd}-cut aqueous extract, step 126, FIG. 2) and BC (1^{st}-cut aqueous extract, step 112, FIG. 1) or to suspensions of ROC (rocks, i.e., crushed solids, without PROTECTORATE) and ROC-P (with PROTECTORATE). 99Tc was added as pertechnetate species (TcO₄₋) at 1200 dpm/mL (approximately 3×10⁻¹⁰ mol/L). Concentrations of BX and BC were each 1% by volume. The suspension concentration of ROC and ROC-P was 40 g/L.

First sampling after 15 minutes of reaction: Samples were mixed end over end then centrifuged five minutes at 4,500 rpm. 0.50 mL of each sample was removed and mixed with 5 mL HiSafe3 LSC cocktail (Liquid Scintillation counting cocktail) and measured for 15 minutes per sample on a Hidex 300SL (Scintillation counter).

Results of first sampling, after 15 minutes of reaction, are summarized in Table 1 below.

TABLE 1

| | Signal | | Measured conc. | Error measured | % | Error % |
|---|---|---|---|---|---|---|
| Sample ID | counts/min. | Error | (dpm/mL) | conc. (dpm/mL) | removal | removal |
| Background | 43.26 | error | — | — | — | — |
| signal | | | | | | |
| Control-I-1 | 678 | 6.723095 | 1269.5 | 26.9 | 0.0% | 0.0% |
| ROC-I-1 | 660 | 6.63325 | 1233.5 | 26.5 | 2.8% | 0.1% |
| ROC-P-I-1 | 685 | 6.757712 | 1283.5 | 27.0 | −1.1% | 0.0% |
| BX-I-1 | 653 | 6.597979 | 1219.5 | 26.4 | 3.9% | 0.1% |
| BC-I-1 | 658 | 6.623192 | 1229.5 | 26.5 | 3.2% | 0.1% |

At second sampling, after three days of reaction, BX and BC each included a visible precipitate, yellow/brown in color, initially, which dissipated. Precipitates appeared white/grey, with the precipitate in BX being present more as a film on walls of the sample vial, presenting a precipitate which had not been removed from solution by centrifugation.

Results of second sampling, after 3 days of reaction, are summarized in Table 2 below.

TABLE 2

| | Signal | | Measured conc. | Error measured | % | Error % |
|---|---|---|---|---|---|---|
| Sample ID | counts/min. | Error | (dpm/mL) | conc. (dpm/mL) | removal | removal |
| Background | 40 | error | — | — | — | — |
| signal | | | | | | |
| Control-I-2 | 678 | 6.723095 | 1269.5 | 26.9 | 0.0% | 0.0% |
| ROC-I-2 | 675 | 6.708204 | 1263.5 | 26.8 | 0.5% | 0.0% |
| ROC-P-I-2 | 661 | 6.638273 | 1235.5 | 26.6 | 2.7% | 0.1% |
| BX-I-2 | 548 | 6.044281 | 1009.5 | 24.2 | 20.5% | 0.7% |
| BC-I-2 | 649 | 6.57774 | 1211.5 | 26.3 | 4.6% | 0.1% |

Summary and analysis of 1^{st} and 2^{nd} sampling data presented in Tables 1 and 2 is provided below.

The 2^{nd}-cut aqueous extract stream (step 126 in FIG. 2) noticeably removed Tc, which appears to have been facilitated by the formation of the white/grey precipitate in the sample, which likely either incorporated the TC or generated a surface for the TC to sorb onto. In either case, it is most likely that the TC is being removed by reduction of TC(VII) to TC(IV), which is quite a difficult challenge, given the relatively high pH of these solutions (pH values ranging from 10 to about 11) and the fact they occur under toxic conditions.

Table 3 provides comparative analyses of radioactive activity levels “before” and “after” treatment.

TABLE 3

| Sample | Methods | Results | DL | RL | Units | PF | DF |
|---|---|---|---|---|---|---|---|
| Water, Before | See note 1 | 197000 | 33.5 | 100 | μg/L | 1.00 | 500 |
| Water, After | See note 1 | 68.1 | 0.0670 | 0.200 | μg/L | 1.00 | 1 |
| Misc. Solids | See note 2 | 0.165 | 0.000670 | 0.00200 | mg/L | 10.0 | 1 |

Comments: Note 1. Prep method performed was EPA 200.2; and the description is ICP-MS 200.2 PREP; also, the analytical method performed was method 1; and the description is EPA 200.8. Note 2. Prep methods performed were SW846 1331, a description of which is SW846 1311 TCLP Leaching; and SW846 3010A, a description of which is TCLP SW 846 3010 Acid Digestion. Also, DL is a “Detection Limit.” RL is a “Reporting Limit.” PF is a “Prep Factor.” DF is a “Dilution Factor.”

Additional illustrative examples of the present subject matter are made as follows:

### Example 2: Removal/Stabilization of Heavy Metals and Radioactive Metals from Water

A liquid product, to stabilize heavy metals, including radioactive metals, is prepared as follows: (Item 1) First, water which includes iron, sulfur, copper, calcium, and magnesium ions is heated to a predetermined temperature. (Item 2) Next, a powder—which includes the following ingredients in measured amounts: crystalline silica, tricalcium silicate, dicalcium silicate, tricalcium aluminate, tetra-calcium aluminoferrite, calcium sulfate dihydrate, calcium oxide, carbon, cadmium, chromium, magnesium, nickel, lead, and chloride—is prepared as a “feedstock”. (Item 3) Thereafter, the feed stock ingredients (item 2) are added and mixed into the hot water (item 1), to produce an aqueous mixture. Then, the following ingredients, in measured amounts, are added and mixed into the aqueous mixture: sulfur, glyoxal, calcium hydroxide, coal, glucose, and sodium hydroxide.

### Example 3: Solids Stabilization of Heavy, Radioactive Metals, Removing them from Water

Combine the hot water (Item 1) described in Example 2 with measured amounts of the following ingredients: tricalcium silicate (3CaO—SiO₂), dicalcium silicate (2CaO—SiO₂), tetra-calcium aluminoferrite (4CaO·Al₂O₃·Fe₂O₃), calcium sulfate (CaSO₄), tricalcium aluminate (3CaO—Al₂O₃), calcium sulfate dihydrate (gypsum) (CaSO₄-2H₂O), calcium carbonate (CaCO₃), and crystalline silica quartz (SiO₂), to produce a stabilized solid containing radioactive metals of Example 3.

### Example 4: Manufacture of a Light-Weight Solid Material Used for Attenuating Radioactivity

Add/Mix vermiculite (Mg, Fe²⁺, Fe³⁺)₃[(Al, Si)₄O₁₀](OH)₂·4H₂O into Example 3.

### Example 5: Foam, Plastic, Chemical Product Radiation Attenuation

In another example, various thickness of a product disclosed herein (BC and/or C) were tested to determine the ability of the product to attenuate radioactivity as compared to lead (Pb), using a Ludlum 9DP-1 ion chamber. “BC” refers to a product with a 1^{st} cut aqueous extract and “C” refers to chemical. Using Cesium 137 as a radioactive source having a calculated radioactivity of 50 mR/hr., radioactivity was measured at 0.99 meters from the source. The results are presented in Table 4.

TABLE 4

| | Measured | |
|---|---|---|
| | Radiation, | |
| Material Component | mR/hr. | % reduction |
| ¾″ Pb | 4.0 | 92.0 |
| ¼″ Pb | 16.3 | 67.4 |
| 4″ BC | 21.0 | 58.0 |
| 6″ BC | 14.2 | 71.6 |
| 8″ BC | 9.0 | 82.1 |
| 4″ C | 27.0 | 46.0 |
| 6″ C | 29.7 | 40.6 |
| 8″ C | 24.9 | 50.2 |
| 4″ BC + 4″ C | 13.6 | 72.8 |
| 12″ BC + steel frame | 3.2 | 93.6 |

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The claimed invention is:

1. A method for stabilizing radioactive isotopes, the method comprising:
preparing a liquid solution;
mixing the liquid solution with Cement Kiln Dust (CKD) powder to form a solid material;
crushing the solid material into particles; and
passing radioactive water through the solid material to remove radioactive isotopes from the radioactive water and stabilize the radioactive isotopes.

2. The method of claim 1, wherein preparing the liquid solution comprises adding iron, sulfur, copper, calcium, and magnesium into hot water to form a first mixture.

3. The method of claim 2, wherein mixing the liquid solution with the CKD powder to form the solid material comprises mixing and combining about 5 weight % of the first mixture with about 20-40 weight % of the CKD powder to produce a second mixture.

4. The method of claim 3, further comprising adding about 10-40 weight % liquid sulfur and xanthan gum glyoxal to the second mixture to produce a third mixture.

5. The method of claim 4, further comprising adding and mixing about 10-30 weight % sodium hydroxide with the third mixture to produce a fourth mixture.

6. The method of claim 5, further comprising adding about 20-100 weight % hot water with the fourth mixture to produce a fifth mixture.

7. The method of claim 6, further comprising separating a first cut solid and a second cut aqueous extract from the fifth mixture.

8. The method of claim 7, further comprising preparing a second cut solid and a second cut aqueous extract from the first cut solid and the second cut aqueous extract.

9. The method of claim 8, further comprising preparing a third cut solid and a third cut aqueous extract from the second cut solid and a second cut aqueous extract.

10. The method of claim 9, further comprising combining the third cut aqueous extract with about 25 weight % cement to produce the solid material.
